(19) United States
(12) Patent Application Publication
(10) Pub. No.: US 2026/0341583 A1
(43) Pub. Date: Oct. 29, 2026

(54) INDUCTOR, METHOD FOR SIMULATION, COMPUTER SYSTEM, COMPUTER PROGRAM PRODUCT

(71) Applicant: SIEMENS AKTIENGESELLSCHAFT, München (DE)

(72) Inventors: Ewgenij Ochs, Puschendorf (DE); Stanislav Panicerski, Nürnberg (DE); Dietmar Schulz, Nordhorn (DE); Philipp Oschmann, Erlangen (DE)

(21) Appl. No.: 19/115,302

(22) PCT Filed: Sep. 1, 2023
(86) PCT No.: PCT/EP2023/074030

§ 371 Date: Mar. 26, 2025

(30) Foreign Application Priority Data
Sep. 26, 2022 (EP) 22197612.9

(51) Int. Cl. H01F 27/29; H01F 27/24; H01F 27/42

(52) U.S. Cl. CPC H01F 27/29; H01F 27/24; H01F 27/42

(57) ABSTRACT

An inductor with at least one core is provided. A core of the least one core with a concave shape at least in sections at least partially encloses a spatial volume. The inductor further includes power connections. To increase the power density, at least some of the power connections are arranged at least partially in the spatial volume.

This application is the National Stage of International Application No. PCT/EP2023/074030, filed Sep. 1, 2023, which claims the benefit of European Patent Application No. EP 22197612.9, filed Sep. 26, 2022. The entire contents of these documents are hereby incorporated herein by reference.

### BACKGROUND

The present embodiments relate to an inductor with at least one core, a core of the at least one core with a concave shape at least in sections at least partially enclosing a spatial volume, where the inductor has power connections.

The present embodiments define an inductor as an electric or electronic element with fixed or adjustable inductor value. The term inductor not only refers to the physical size with the henry unit, but also to the inductive electric and electronic element. In power electronics, inductors are configured as passive components that limit currents in electrical lines, buffer energy in the form of a magnetic field, and adjust impedance. Inductors are also used for filtering. These inductors include, for example, coils, transducers, baluns, chokes, and transformers. Subsequently, the terms inductor, coil, and choke are used synonymously.

As with all other components in power electronics, inductors require ever greater power densities in order to develop even more compact filter elements or filter-integrated frequency converters.

An annular coil with external terminal contacts is already known in each case from US 2013/278369 A1 and EP 3 096 336 B1.

A coil with a pot core is known from EP 0 939 412 B1. A coil with a cuboid core is known from US 2010/214050 A1.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a power density of an inductor is increased.

In the development of inductors, optimization has so far focused on two areas. One focus is the area of the choke core and the choke winding. The other focus is connection technology. Depending on power and depending on currents, conventional connection technology may take up to 25% of the total choke volume.

The present embodiments increase the power density for induction. The present embodiments also lead to a higher integration of all inductor elements.

For example, at least some of the power connections may be arranged at least partially in the spatial volume, which is at least partially enclosed by the inductor. This results in a relocation of the connection technology in a previous dead space of the components and also a reduction in the volume of the connection technology as a result of the shortening of the connection paths. The present embodiments relate not only to the inductor itself but also to arrangements having this inductor according to the present embodiments (e.g., also according to a development of the present embodiment). For example, a corresponding arrangement with an inductor according to the present embodiments may be a filter assembly or a transformer, each including an inductor according to the present embodiments.

According to the present embodiments, the core of the inductor is configured as a partial ring or as a closed ring. The ring or partial ring may be of any shape (e.g., deviating from a circular shape; oval, egg-shaped, rectangular, or polygonal).

According to the present embodiments, the power connections are elongated (e.g., in the form of bolts or current bolts) for the electrical contacting of a printed circuit board, for example. The power connections have two ends and are conductively connected to a winding of the inductor in the area of the first end of the two ends and are prepared or provided at a second end of the two ends for connection to adjacent elements.

In one embodiment, the inductor is composed of at least two individual inductors, in which the core with a concave shape at least in sections at least partially encloses a spatial volume. The at least two individual inductors are arranged in such an adjacent manner that the spatial volumes of the at least two individual inductors are arranged adjacent to one another, so that a common spatial volume is formed from the spatial volumes of the at least two individual inductors. The power connections of the at least two individual inductors are arranged in the common spatial volume. In this way, installation space is saved with two or more inductors, as multiple current-conducting connections, such as, for example, current bolts, may be made in a space-saving manner through the two toroidal chokes in the common spatial volume. This results in an internal wiring of both inductors, and the volume of the arrangement is not enlarged unnecessarily.

To improve mechanical integrity, at least one holder element attached to the inductor is arranged in the spatial volume. The at least one holder element is mechanically connected to at least some of the power connections in order to keep the power connections in a specific spatial position. The holder element may be produced from injection molding or as an insulating glass fiber reinforced plate (GRP). Further, the current bolts may be overmolded in a molding method so that all current bolts and the holder element may be formed into a mechanical unit. Additionally, the holder element may be made of a non-conductive material or may be attached in an electrically insulated manner to at least some of the power connections to be supported.

Alternatively, the holder element may be electrically conductively connected to at least some of the power connections as a component-equipped conductor element or as a component-equipped printed circuit board. This embodiment not only saves space above the inductor but also reduces the impedance of the connecting line as the connection of the components (e.g., capacitors) may be very short.

An application of the present embodiments may include the inductor according to the present embodiments being installed from one or more individual inductors in a filter device or a filter-integrated frequency converter.

The present embodiments and the developments result in a compact system with decisive advantages: 1) applications with internally-guided power connections enable more compact connection technology than with conventional power connections placed outside the inductors; 2) two or more inductors may be stacked on top of one another and interconnected in a space-saving manner with, for example, internally-guided power connections or current bolts; 3) an assembly or inductor linked in such a novel manner enables the direct connection of adjacent elements (e.g., filter capacitors) at a short distance without parasitic inductor components; 4) the production of such an inductor according to the present embodiments may take place in a semi-or fully automated assembly as the power connections, or current bolts are ideally aligned with one another; 5) holder elements used in the interior insulate the power connections from one another and keep the winding of the inductor at a defined distance from the cores; 6) the design according to the present embodiments enables the connection of further components (e.g., filter capacitors) in the intermediate space to the choke.

A development provides a computer-implemented method for simulating a machine according to the present embodiments or one of its developments. For this purpose, a computer system including at least one computer is configured for simulation according to the method. The computer or the computer system may be prepared for this purpose by a corresponding computer program product for performing a method according to the present embodiments or one of its developments.

The core may be a magnetic core.

In one embodiment, either a ferromagnetic metal alloy, for example, in the form of sheet metal or foil (e.g., electrical strip, metallic glass) or bonded powder (e.g., powder core) is used as the material for the core, or an oxide ceramic ferromagnetic material (e.g., ferrite) is used.

The core is configured as a closed core, at least in the operating state. In this case, the core may also be modular in design, so that the closed form is only present in the ready-to-use composition (e.g., from two individual inductors).

The core has an annular shape. In this case, the spatial volume enclosed by the concave shape is determined by a radial interior of the annular shape due to the annular shape of the core, so that at least some of the power connections of the inductor are arranged at least partially in the radial interior of the annular shape.

An electrical winding may be wound around the, for example, closed core or toroidal core, and the power connections may be used to connect the winding to a power supply in an electrically conductive manner.

### BRIEF DESCRIPTION OF THE DRAWINGS

FIG. 1 shows a diagrammatic, simplified three-dimensional view of a first variant of an inductor according to an embodiment;

FIG. 2 shows a diagrammatic, simplified three-dimensional, partially sectioned view of an inductor according to an embodiment consisting of two individual inductors arranged one above the other;

FIG. 3 shows the inductor according to FIG. 2 with associated additional elements;

FIG. 4 shows a diagrammatic, simplified three-dimensional, partially sectioned view of an inductor according to an embodiment consisting of two individual inductors arranged one above the other with elements integrated into the enclosed volume; and

FIG. 5 shows a diagrammatic view of a simulation of operation of an inductor according to an embodiment running on a computer, a computer program product.

### DETAILED DESCRIPTION

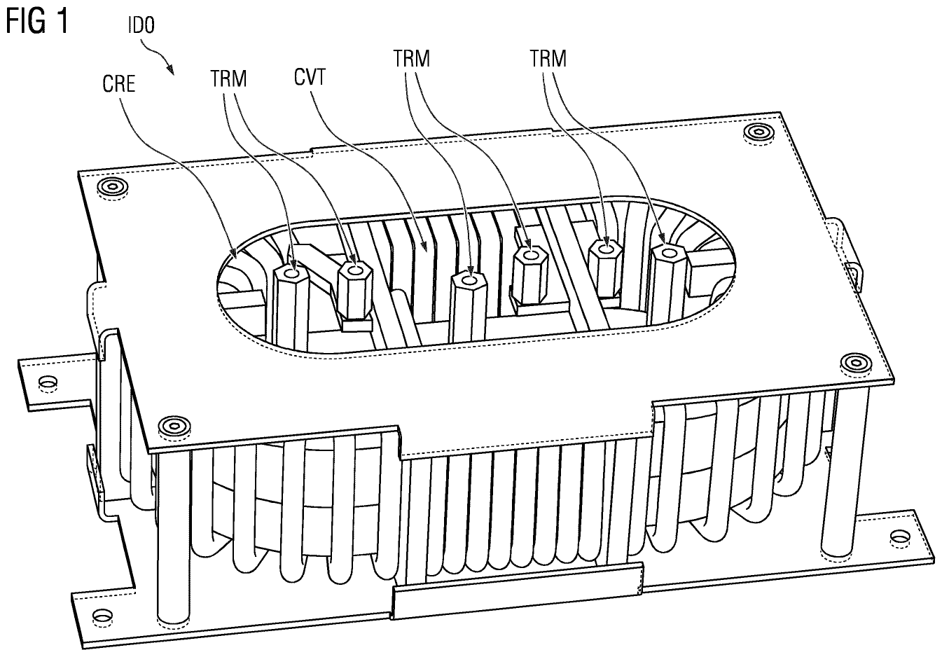

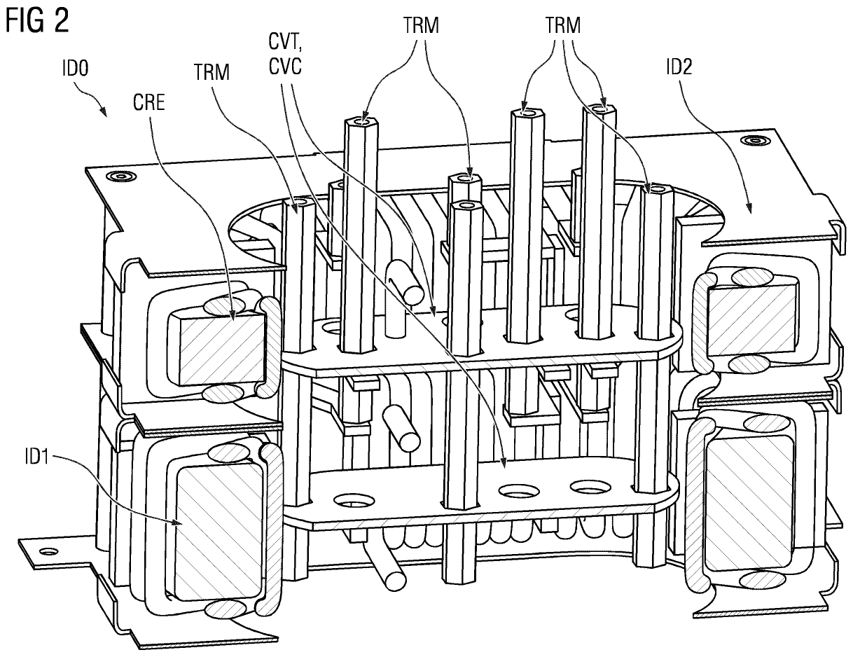

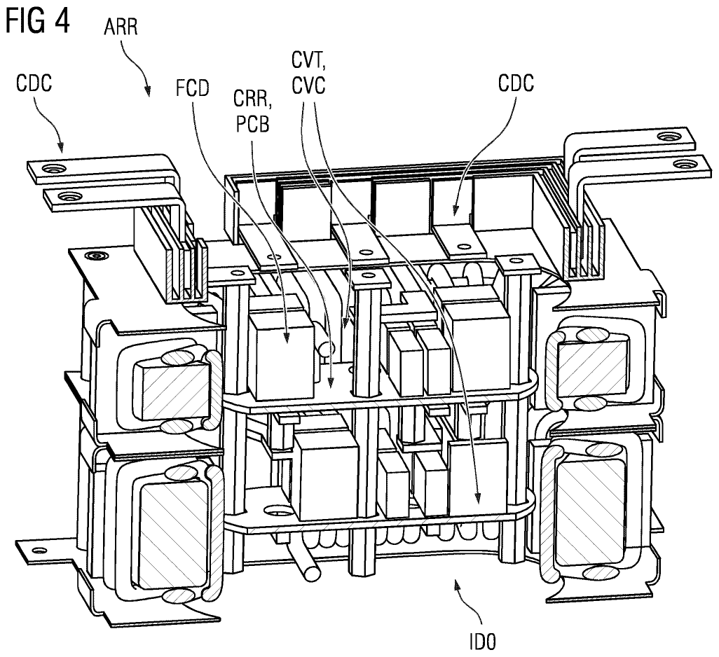

FIGS. 1-4 each show diagrammatic, simplified, three-dimensional variants of an inductor according to the present embodiment. FIGS. 2, 3 and 4 are shown here partially sectioned in order to provide a view of the interior (e.g., the enclosed spatial volume) of the inductor IDO according to the present embodiment shown. The inductor IDO of FIG. 1 has a core CRE that encloses a spatial volume CVT with a concave contour or shape. The core CRE may have an annular shape. The inductor has power connections TRM. The power connections TRM are arranged in the spatial volume CVT, but may also protrude partially from the spatial volume CVT in a manner not shown or may be arranged completely in the spatial volume CVT. The inductor IDO uses the spatial volume CVT, which is always present in toroidal/oval and rectangular core chokes, for example, and integrates the electrically conductive three-phase connection technology or the power connections TRM into this intermediate space. In an arrangement according to FIG. 4, further elements are integrated into the spatial volume CVT, CVC (e.g., filter capacitors).

FIG. 2 shows an inductor IDO according to the present embodiment, the inductor ID0 being composed of two individual inductors ID1, ID2. The two individual inductors ID1, ID2 are arranged adjacent to one another such that the spatial volumes CVC are arranged adjacent to one another. In this way, a common spatial volume CVC is formed from the adjacent spatial volumes CVT of the individual inductors ID1, ID2. The power connections TRM of the individual inductors ID1, ID2 are arranged in the common spatial volume CVC.

As shown in FIG. 2, a holder element CRR attached to the inductor IDO is arranged in the spatial volume CVT. The holder element CRR is mechanically connected to the power connections TRM such that the power connections TRM are held in a specific spatial position. In FIG. 2, the holder element CRR is made of a non-conductive material or is electrically insulating and is attached to the power connections TRM to be supported. The holder element CRR provides that windings, cores CRE, and power connections TRM, or current bolts, are held in position. This holder element CRR may, for example, be produced from injection molding or an insulating glass fiber reinforced (GRP) plate. Further, the current bolts may be overmolded in a molding method so that all the current bolts and the insulation holder may become one unit.

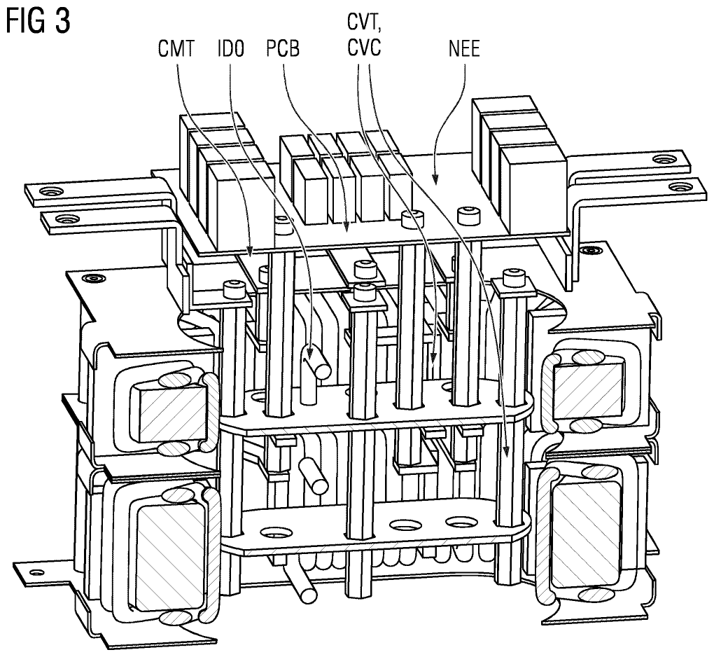

FIG. 3 shows the inductor IDO of FIG. 2 in an example combination with adjacent elements NEE. The connection situation is space-saving. Some power connections TRM contact a printed circuit board PCB directly, and others are connected to a separate conductor metal CMT.

FIG. 4 shows an embodiment or an arrangement ARR with an inductor according to the present embodiment, in which the holder element CRR is electrically conductively connected to at least some of the power connections TRM as a component-equipped printed circuit board PCB. This connection technology enables the connection of filter capacitors FCD, for example, to the center of the two chokes, with a short distance. This is very useful so that no parasitic inductors arise on the filter capacitors. The filter capacitors FCD may, for example, be soldered onto the printed circuit board, so that the assembly of the entire system may be carried out much more quickly. However, the filter capacitors may also be connected without a printed circuit board, for example, by wire leads from filter capacitors directly to the current bolts or to the inductors. Further connections of the choke assembly (e.g., input and output of filter device) are made, for example, by three-phase busbars or flexible or rigid power lines CDC.

Alternatively, the filter capacitors FCD may be integrated into the intermediate space such that the filter capacitors FCD are connected directly to the center of the inductors with short lines. These arrangements not only save space above the inductor IDO but also reduce the impedance of the connecting lines, as the connection of the adjacent elements is very short.

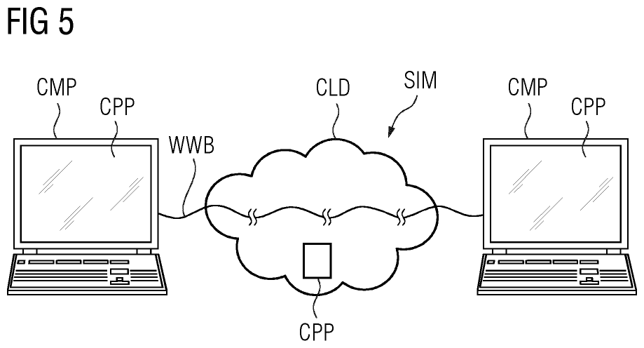

FIG. 5 shows a diagrammatic view of a simulation SIM of the inductor IDO according to the present embodiment running on a computer CMP (e.g., on multiple computers CMP of a network WWB including a cloud CLD). The software installed on the computers CMP is a computer program product CPP that, when executed on at least one computer CMP, enables the user to exert influence or configure and gain knowledge based on the executed simulation SIM using interfaces (e.g., using a screen and keyboard), so that, for example, decisions concerning technical design may be supported and verified by the simulation.

Although the invention has been illustrated and described in more detail by the example embodiments, the invention is not limited by the disclosed examples. Variations thereof may be derived by a person skilled in the art without departing from the scope of the invention as defined by the following claims.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An inductor with at least one core, wherein a core of the at least one core with a concave shape at least in sections at least partially encloses a spatial volume, the inductor comprising:
power connections,
wherein the core of the inductor configured as a closed ring,
wherein at least some of the power connections are arranged at least partially in the spatial volume,
wherein the power connections have two ends and are conductively connected at a first end of the two ends to a winding of the inductor and are provided at a second end of the two ends for connection to adjacent elements,
wherein the spatial volume enclosed by the concave shape is arranged in a radial interior of an annular shape due to the annular shape of the core, so that at least some of the power connections of the inductor are arranged at least partially in the radial interior of the annular shape.

2. The inductor of claim 1, wherein the inductor is composed of at least two individual inductors, in each of which the core of the at least one core with a concave shape at least in sections at least partially encloses a spatial volume, arranged in such an adjacent manner that the spatial volumes of the at least two individual inductors are arranged adjacent to one another, so that a common spatial volume is formed from the spatial volumes of the at least two individual inductors, and
wherein the power connections of the at least two individual inductors are arranged in the common spatial volume.

3. The inductor of claim 1, wherein at least one holder element that is fastened to the inductor and is mechanically connected to at least some of the power connections is arranged in the spatial volume, such that the power connections are supported in a specific spatial position.

4. The inductor of claim 3, wherein the at least one holder element consists of a non-conductive material or is attached in an electrically insulated manner to at least some of the power connections to be supported.

5.-7. (canceled)

8. The inductor of claim 4, wherein the at least one holder element is injection molded or is formed from an insulating glass fiber reinforced plate.

9. The inductor of claim 1, wherein the at least one holder element is electrically conductively connected to at least some of the power connections.

10. The inductor of claim 9, wherein the at least one holder element includes a component-equipped conductor element or a component-equipped printed circuit board.

11. The inductor of claim 9, wherein the at least one holder element is configured to receive one or more filter capacitors.

12. The inductor of claim 1, wherein the spatial volume is further arranged and configured for integration of filter capacitors.

13. The inductor of claim 12, wherein the filter capacitors are connected directly to the inductor via short lines, wire leads, three-phase busbars, or power lines.

14. The inductor of claim 1, wherein at least one holder element that is fastened to the inductor and is mechanically connected to at least some of the power connections is arranged in the spatial volume, such that the power connections are supported in a specific spatial position.

15. The inductor of claim 14, wherein the at least one holder element consists of a non-conductive material or is attached in an electrically insulated manner to at least some of the power connections to be supported.
